(19) United States
(12) Patent Application Publication
(10) Pub. No.: US 2012/0082068 A1
(43) Pub. Date: Apr. 5, 2012

(54) APPARATUSES, SYSTEMS AND METHODS USING MULTI-FUNCTIONAL ANTENNAS INCORPORATING IN-LINE-FILTER ASSEMBLIES

(76) Inventors: Songnan Yang, San Jose, CA (US); Ulun Karacaoglu, San Diego, CA (US); Xintian E. Lin, Palo Alto, CA (US); Anand S. Konanur, San Jose, CA (US)

(21) Appl. No.: 13/078,377

(22) Filed: Apr. 1, 2011

Related U.S. Application Data
(63) Continuation-in-part of application No. 12/590,353, filed on Nov. 6, 2009.

(51) Int. Cl. H04B 7/02; H04W 92/00; H04B 7/00; H04B 1/04

(52) U.S. Cl. 370/277; 455/114.2; 455/101; 370/310

(57) ABSTRACT

Embodiments herein may provide an apparatus, comprising an antenna, the antenna including a same radiating element fed by more than one in-line-filter cables with complimentary pass and rejection bands, wherein the more than one in-line-filter cables have periodically inserted discontinuities in coaxial cables to create band rejection filter functionalities.

### CROSS REFERENCED TO RELATED APPLICATIONS

The present application is a continuation-in-part of U.S. patent application Ser. No. 12/590,353, filed Nov. 6, 2009, entitled “Radio frequency Filtering in coaxial cables within a computer system” by Karacaoglu et al.

### BACKGROUND

Typically multiple radios co-located on the same computer platform, particularly laptops, notebook and netbook computer systems, need high isolation to function optimally. This high isolation between the two radios prevents the two radios from interfering with the other radio's reception. Conventionally, this essential isolation is typically achieved through a high isolation between the two radios' antennas and highly selective filters on the radio receiver side of conventional radio architecture.

As more and more radios and antennas are integrated in a computer system, there is an increasing difficulty in achieving a high isolation between closely spaced antennas. As a result, a more stringent filter requirement is forced upon the wireless module. However, due to cost and real estate constraints, the performance of the front-end filter on the wireless module is usually compromised. Consequently a major portion of radio co-existence issues in current computer systems, and more particularly mobile computing systems such as laptops, notebooks and netbooks, are caused by front-end saturation due to strong out-of-bound (OOB) interference from other embedded radios operating at a nearby frequency band.

Additionally, in a computer system comprising a single radio, excessive filtering is usually required to reject spurious emission of transmission in order to obtain regulatory compliance. This filtering is sometimes found to be inadequate in a radio module prototype or hard to achieve on a low cost radio solution. Currently, to solve these problems at a modular level usually incurs significant cost increases and time to market delays.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a typical notebook computer system having multiple wireless radio modules and multiple antennas.

FIG. 2 illustrates conventional radio architecture.

FIG. 3 illustrates an in-line-filter radio architecture in accordance with one embodiment.

FIG. 4 illustrates a coaxial cable.

FIG. 5 illustrates a first embodiment of a modified coaxial cable.

FIG. 6 illustrates a second embodiment of a modified coaxial cable

FIG. 7 illustrates an example showing a simulated insertion loss of an in-line-filter.

FIG. 8 illustrates method steps according to an embodiment.

### DETAILED DESCRIPTION

In the following discussion, an exemplary environment is first described that is operable to employ radio frequency (RF) filtering in RF coaxial cables. Exemplary devices and procedures are then described that may be employed in the exemplary environment, as well as in other environments.

### Exemplary Embodiment

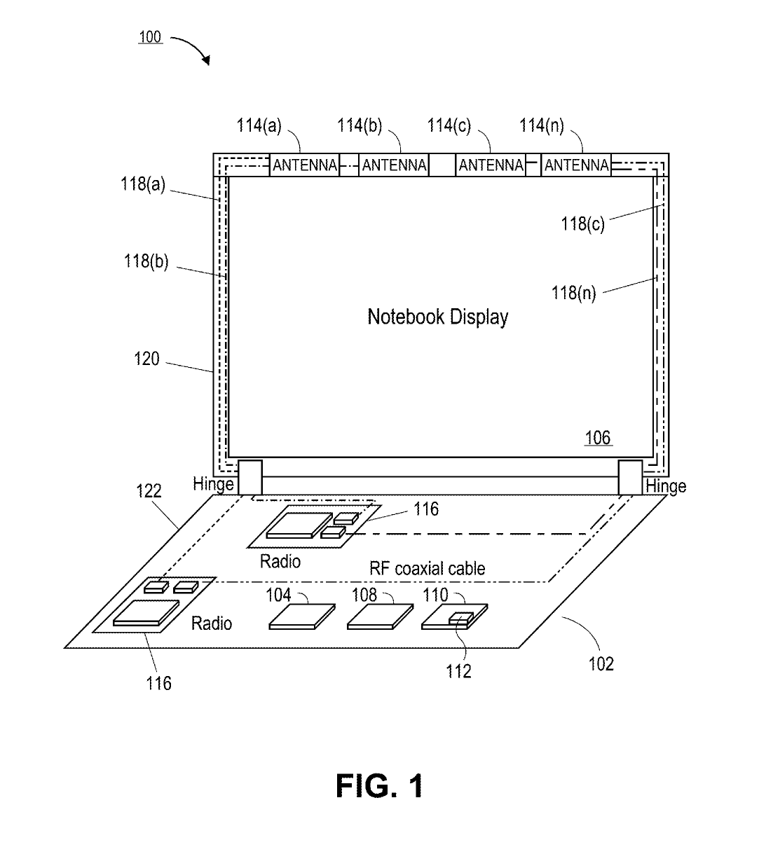

FIG. 1 illustrates an exemplary implementation of an environment 100 that is operable to employ radio frequency (RF) filtering in RF coaxial cables described herein. The environment 100 is depicted as having a computing device 102 which includes a processor core 104. Computing device 102 represents a variety of host devices/systems which may be configured in a variety of ways including but not limited to a desktop personal computer (PC), a laptop, an ultra mobile pc (UMPC), a handheld computing device, a game console, a multimedia appliance, a digital recording device for audio/video, and so forth. The processor core 104 represents a processing unit of any type of architecture which has the primary logic, operation devices, controllers, memory systems, and so forth of the computing device 102. For instance, the processor core 104 may incorporate one or more processing devices and a chipset having functionality for memory control, input/output control, graphics processing, and so forth.

In an implementation, the processor core 104 may be communicatively coupled via an interconnect (not shown) to a network interface device, a display device 106 (e.g., a liquid crystal display), and/or a plurality of input/output (I/O) devices. The interconnect represents the primary high speed interconnects between components/devices of the host computing device 102, such as those employed in traditional computing chipsets. The interconnect may be point-to-point or connected to multiple devices (e.g., bussed).

The network interface device 108 represents functionality to provide the computing device 102 a connection to one or more networks, such as the Internet, an intranet, a peer-to-to peer network, and so on. The network interface 108 may be configured to provide a wireless and/or wired connection, and to perform a variety of signal processing functions associated with network communications.

The display 110 may be configured in variety of ways including but not limited to a conventional monitor, a liquid crystal display (LCD), a projector, and so forth. The I/O devices represent a variety of I/O devices which may be provided to perform I/O functions, examples of which include controllers/devices for input functions (e.g., keyboard, mouse, trackball, pointing device), media cards (e.g., audio, video, graphic), network cards and other peripheral controllers, LAN cards, speakers, camera, and so forth.

Processor core 104 may also be coupled via a memory bus (not shown) to a memory 108 which in an embodiment represents “main” memory of the computing device 102 and which may be utilized to store and/or execute system code and data. The “main” memory 108 may be implemented with dynamic random access memory (DRAM), static random access memory (SRAM), or any other types of memories including those that do not need to be refreshed. The “main” memory 108 may include multiple channels of memory devices such as DRAMs. The DRAMs may include Double Data Rate (DDR2) devices.

Other memory 110 may also be provided which represents a variety of storage such as hard drive memory, removable media drives (for example, CD/DVD drives), card readers, flash memory and so forth. The other memory may be connected to the processor core 104 in a variety of ways such as via Integrated Drive Electronics (IDE), Advanced Technology Attachment (ATA), Serial ATA (SATA), Universal Serial Bus (USB), and so on. Other memory 110 is depicted as storing a variety of application modules 112(m) which may be executed via processing components and memory components to provide a variety of functionality to the computing device 102. Examples of application modules 112(m) include but are not limited to an operating system, a browser, office productivity modules, games, email, photo editing and storage, multimedia management/playback, and so on. A variety of other examples are also contemplated.

FIG. 1 further illustrates the computing device 102 as including multiple antennas 114(a) through 114(n), wherein the integer n represent any number of possible antennas. Each antenna 114 is communicatively coupled to a wireless radio module 116 via a radio frequency (RF) coaxial cable 118(a) through 118(n). Conventionally, each antenna 114 is located within a notebook computer system at the top of the lid 120 while the wireless radio modules 116 are located within the base 122.

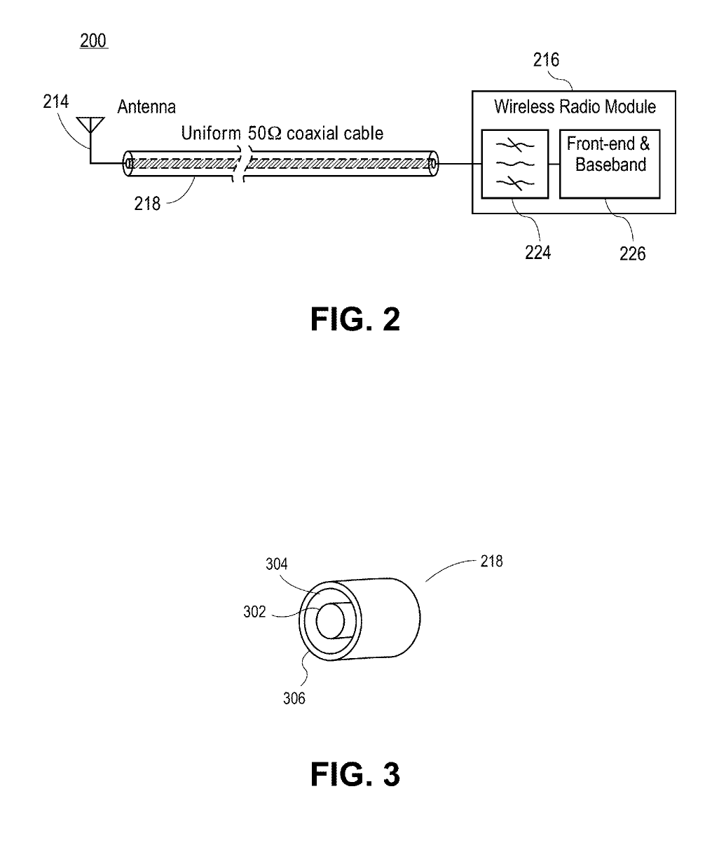

Reference is now made to FIG. 2. FIG. 2 depicts a radio structure 200. The radio structure 200 comprises an antenna 214 communicatively coupled to the wireless radio module 216 via a uniform RF coaxial cable 218. Uniform RF coaxial cable 218 provides a uniform impedance of 50Ω along the length of the RF coaxial cable 218. The wireless radio module 216 includes band pass filter 224 with stringent specifications to reject out of band interference from non-desired radio frequencies. Additionally, the wireless radio module 216 will further include additional front-end and baseband filters 226.

Referring now to FIG. 3, Uniform RF coaxial cable 218 is an electrical cable with an inner conductor 302 surrounded by a tubular insulating layer 304 typically of a flexible material with a high dielectric constant. Both the inner conductor 302 and the insulating layer 304 are surrounded by a conductive layer 306 (also referred to as the metallic shield). Typically, the conductive layer 306 comprises a fine woven wire or a thin metallic foil. The three layers are then covered with a thin insulating layer (not shown). Generally, the impedance of the coaxial cable is determined from the ratio of the inner conductor's 302 diameter to the inner diameter of the conductive layer 306.

The length of an RF coaxial cable has little to do with the impedance of the RF coaxial cable. Instead, impedance is determined by the size and spacing of the conductors and the type of dielectric used between them. For ordinary coaxial cable used at a reasonable frequency, the characteristic impedance depends on the dimensions of the inner and outer conductors, and on the characteristics of the dielectric material between the inner and outer conductors. The following formula can be used for calculating the characteristic impedance of the coaxial cable:

impedance=(138/ê(1/2))*log(D/d)

Wherein log equals the logarithm of 10 and d equals the diameter of the inner conductor, D equals the inner diameter of the cable shield and e equals the dielectric constant.

To improve the isolation between multiple antennas 114 of the computing device 102, the coaxial cables 118 can be modified to incorporate band pass filter functionalities. The implementation of such “in-line-filter” provides additional filtering to the discrete filter on the wireless radio modules 116. The additional filtering thus renders improved radio coexistence performance. Additionally, in a computing device 102 having a single radio 116 and antenna 114, the additional filtering can achieve lower spurious emission, thus lowering the risk of failing individual regulatory test. For both multiple radio and single radio systems, the inclusion of additional filtering provided at the RF coaxial cable 118 can provide a cost reduction by reducing the need for a more stringent filter 224 at the wireless radio module.

In order to achieve a band bass filter response within the RF coaxial cable 118, the impedance of the RF coaxial cable 118 needs to be strategically tapered through changing the RF coaxial cable's 118 mechanical structure at periodic sections along the RF coaxial cable's 118 length. By changing the RF coaxial cable's 118 mechanical structure, the cable allows RF signals within certain frequency band(s) to pass with minimal attenuation, while in other frequencies, the RF signal is either reflected or attenuated.

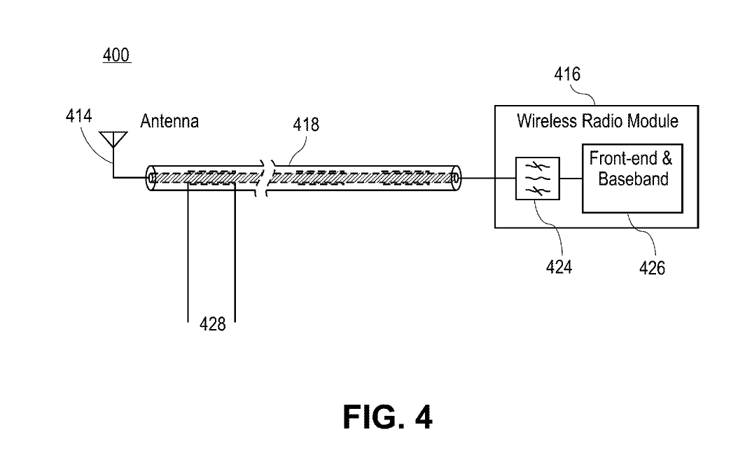

FIG. 4 depicts a conventional radio structure 400 comprising in part a modified RF coaxial cable 418. Radio structure 400 comprises an antenna 414 and a wireless radio module 416 connected via a modified RF coaxial cable 418. Modified RF coaxial cable 418 is a typical RF coaxial cable wherein the mechanical structure has been modified to allow variation in impedance along the RF coaxial cable in order to allow certain frequency band(s) to pass.

The mechanical structure of the RF coaxial cable 418 is modified by inserting sections 428 of higher and/or lower impedance along the length of the RF coaxial cable 418. The length of each section can be optimized such that the variation in cable impedance is transparent to an RF signal in another band.

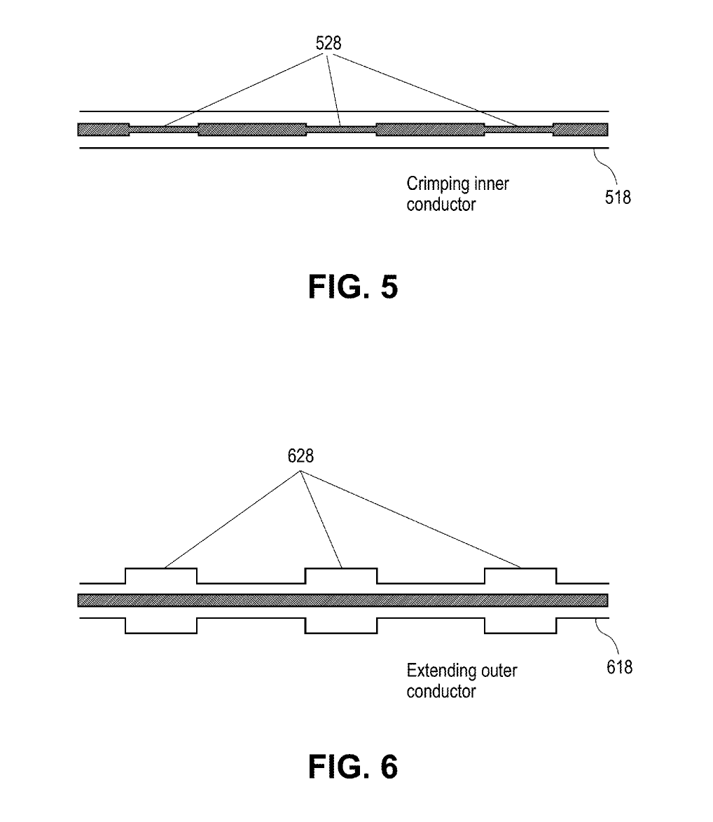

FIG. 5 depicts a first embodiment of the modified RF coaxial cable 518 that has been modified by inserting sections 528 of altered impedance. The RF coaxial cable 518 has been modified by crimping the inner conductor of the modified RF coaxial cable 518. Wherein, crimping the inner conductor, and not modifying the conductive layer, changes the ratio of the inner conductor diameter to the diameter of the outer conductive layer, thus changing the impedance of the sections 528.

FIG. 6 depicts a second embodiment of the modified RF coaxial cable 618 that has been modified by inserting sections 628 of altered impedance. The RF coaxial cable 618 has been modified by extending the diameter of the conductive layer. Wherein, extending the outer conductive layer, and not modifying the diameter of the inner conductor, changes the ration of the inner conductor diameter to the diameter of the outer conductive layer, thus changing the impedance of the sections 628.

The sections of changed impedance can be modified in multiple other ways known to those of skill in the pertinent art. Additional examples of altering the impedance along the RF coaxial cable include changing materials within these sections, changing the cross-sectional shape of each conductor within the section, or changing the properties of the insulating material between the two conductors within the sections of the RF coaxial cable.

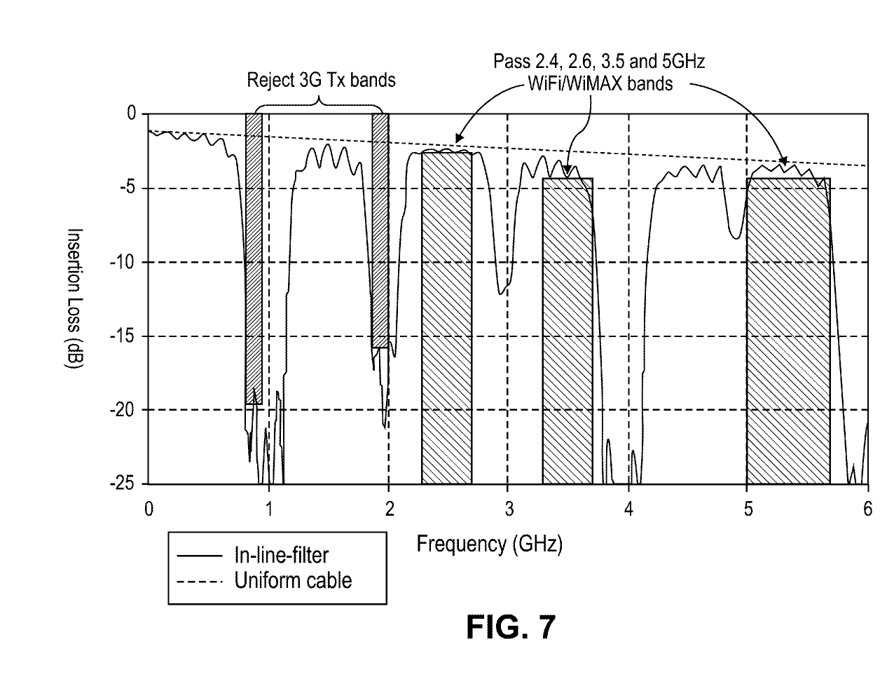

An example is shown in the simulated insertion loss of an in-line-filter as shown at FIG. 7. The additional embedded filter distributed along the antenna cable improves the isolation between antennas of two different radios operating at close frequency bands, lowering susceptibility to front-end saturation due to very strong Out of Band (OOB) interference signals. Additionally, the inclusion of the additional embedded filter distributed along the antenna cable improves the radio co-existence performances.

For example, the antenna cable of a 2.4 GHz WiFi radio can be designed to have a rejection band at 2 GHz to improve the antenna isolation between WiFi and 3G antennas and provide stronger rejection to uplink signal around 2 GHz transmitted by a 3G radio co-located on the same computing device platform and operating concurrently. Similarly, an in-line-filter can also be implemented to the Bluetooth radio transmitting at 2.4 GHz to limit its out of band emission in 2.5 GHz band, which could significantly degrade a WiMax radio's performance. Another usage model utilizes the in-line-filter in a DTV radio to reject 3G (700-900 MHz) uplink signal to ensure a good UHF DTV reception.

### Exemplary Method

An in-line-filter as described above can be fabricated from traditional micro-coaxial cable by periodically crimping the micro-coaxial cable to achieve a changed impedance section. More particularly, the micro-coaxial cable can be modified to have section of low impedance by crimping the micro-coaxial cable to change the inner conductor's diameter relative to the diameter of the outer conductor layer.

The in-line-filter can be manufactured with variable spacing between the modified sections of the micro-coaxial cable. The more modified sections that are inserted into the fixed length of the RF coaxial cable between the antenna and the wireless radio module, the better the RF coaxial cable will act as an in-line-filter. But with the increase in the number of modified sections, the more the desired signal is lost also. The more powerful the signal, the more the RF coaxial cable can be modified as there is a greater signal power to be lost.

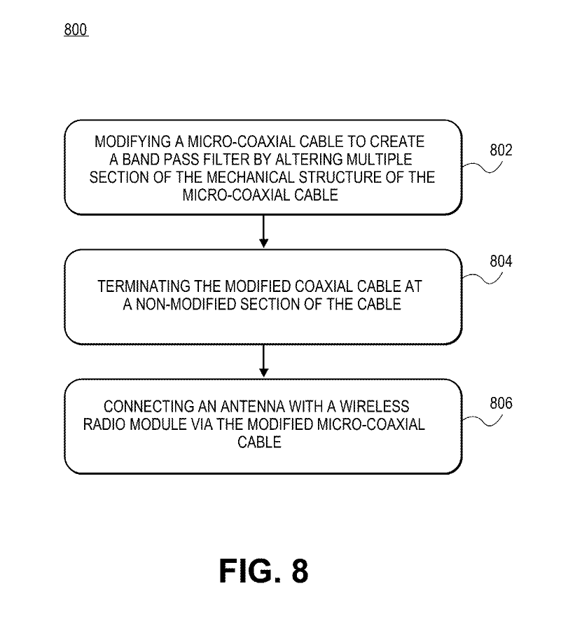

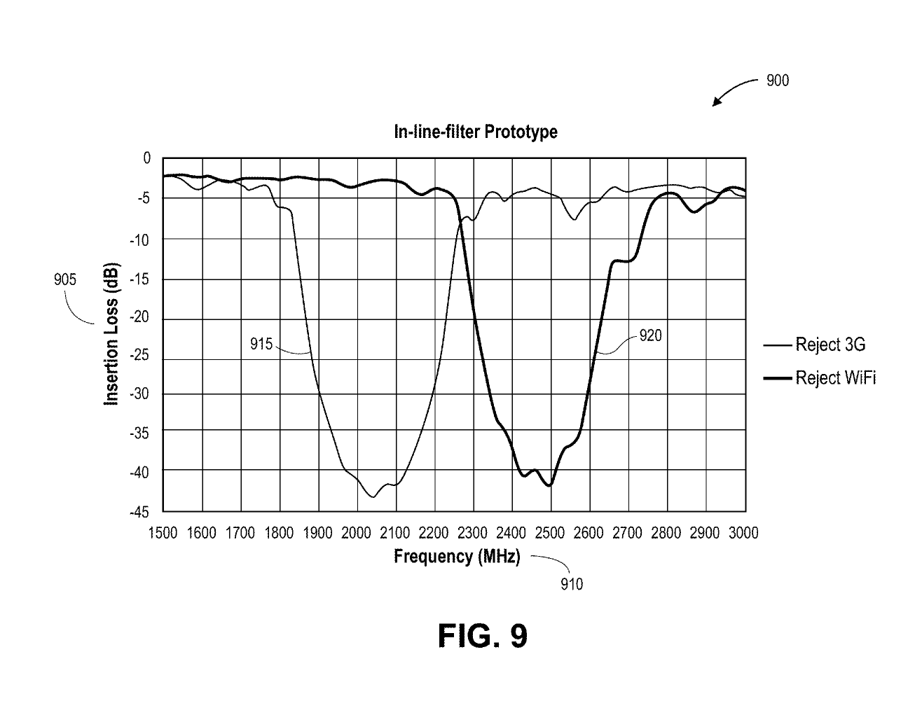

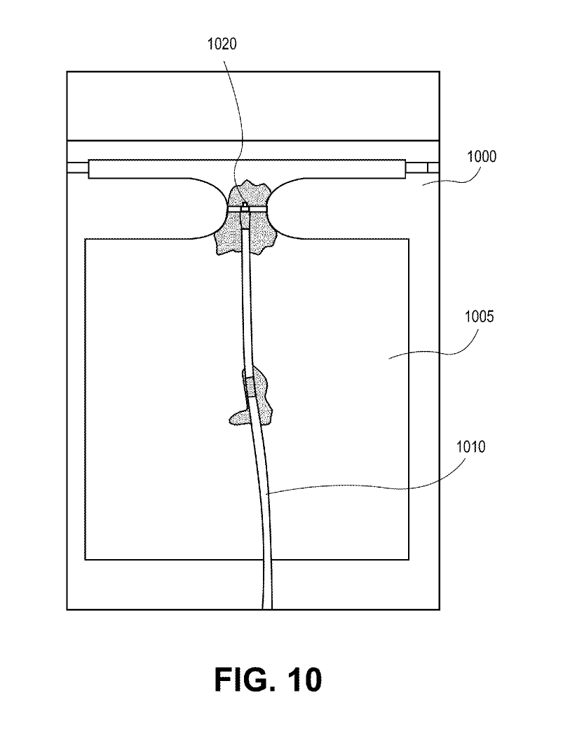

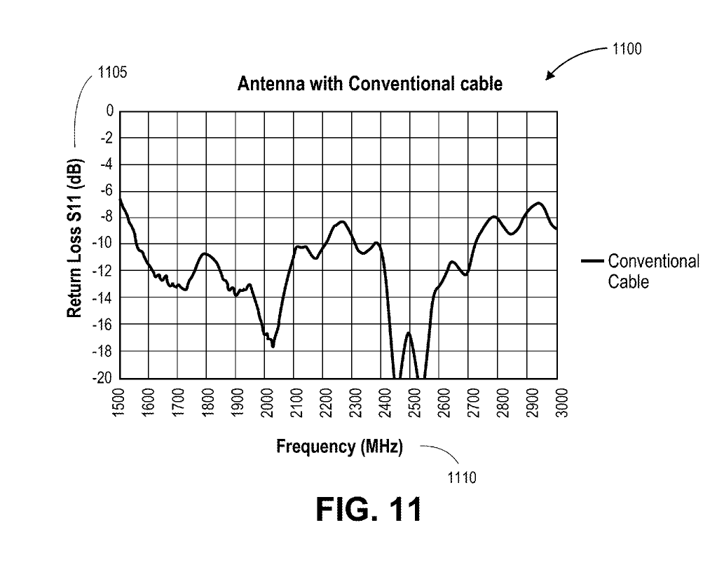

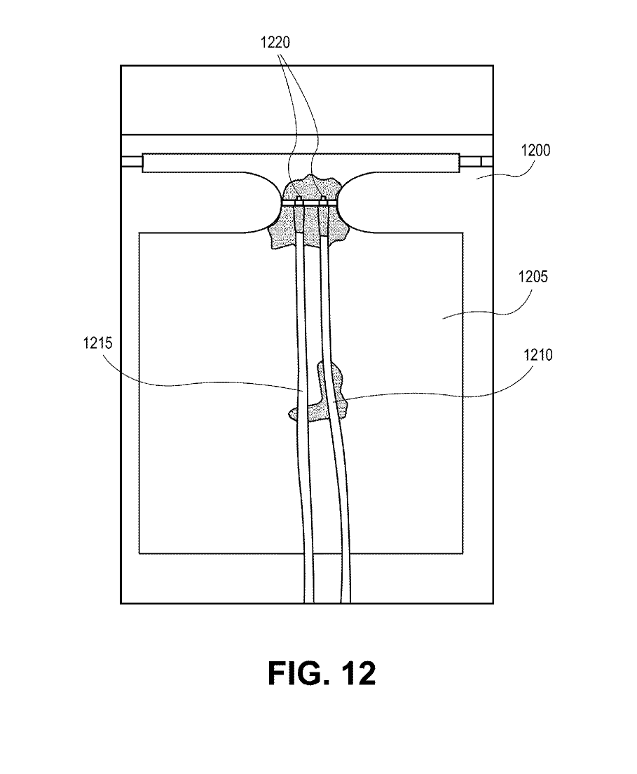

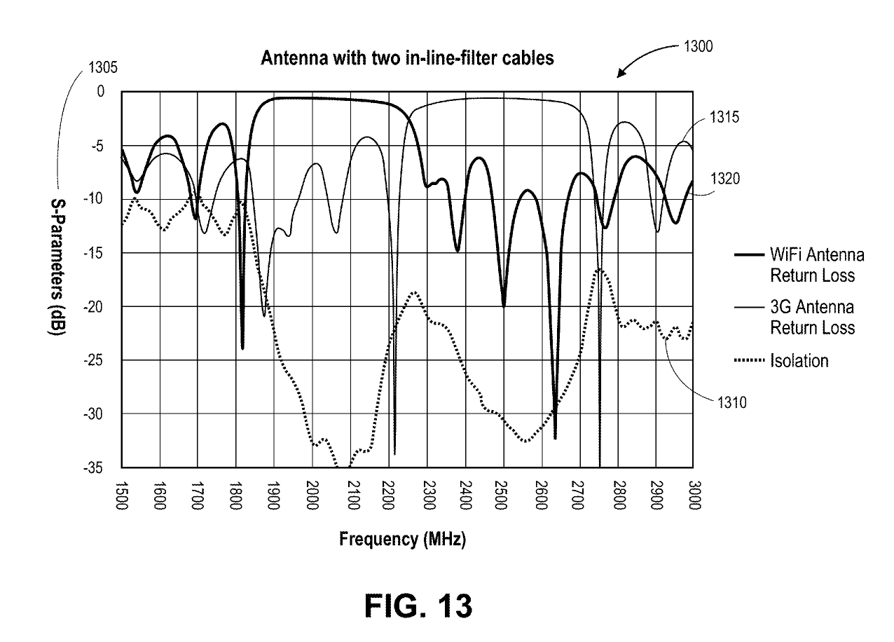

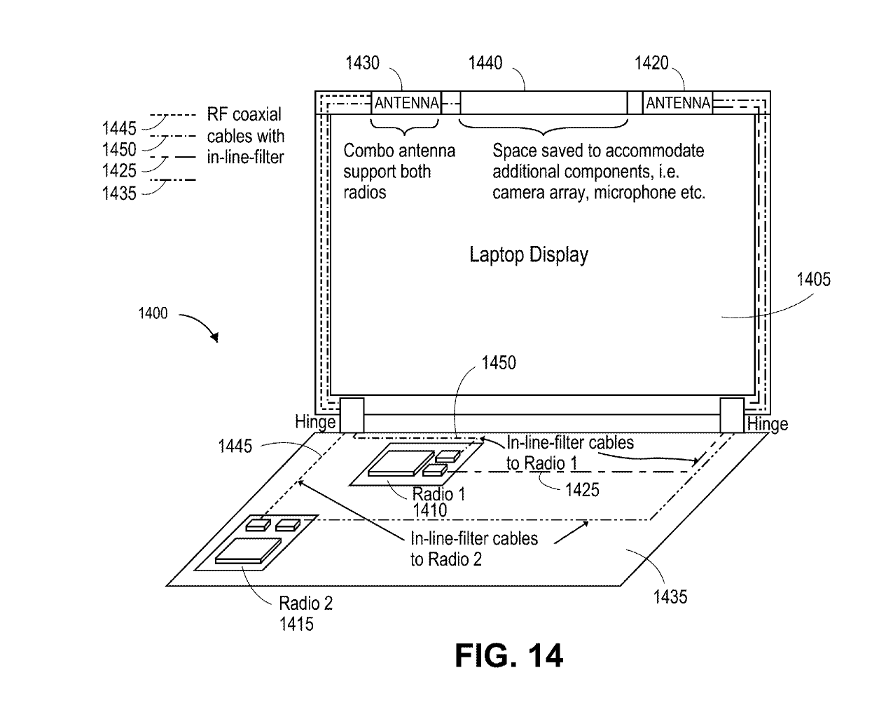

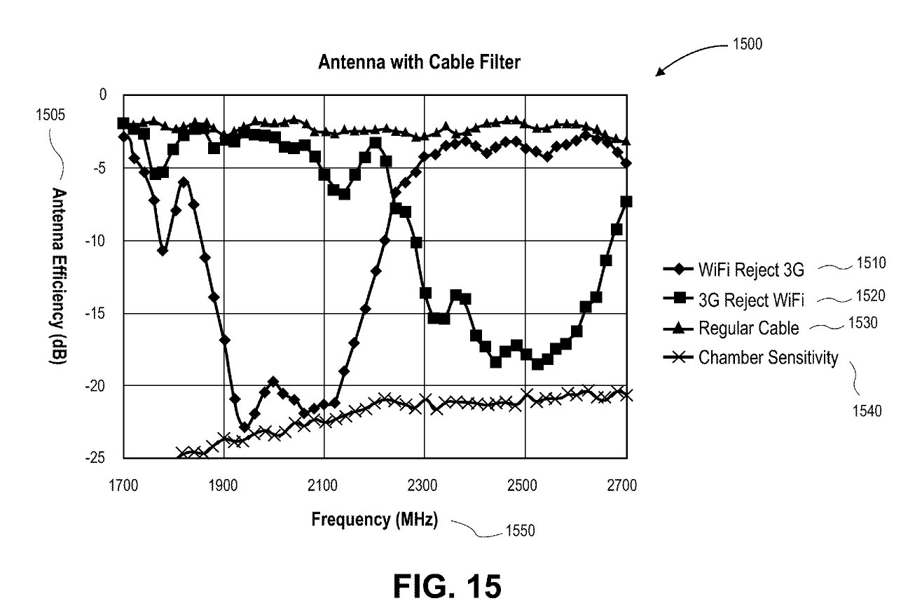

FIG. 8 depicts a flowchart 800 that describes a method in accordance with one embodiment. In describing the method of flowchart 800, reference is made to the computing device 102 of FIG. 1. It is to be understood, however, that the method of flowchart 800 is contemplated to be broadly applicable to a vast range of computing devices, and is not to be limited in its use only in connection with the exemplary embodiment of FIG. 1.

At 802, a micro-coaxial cable (e.g., 118(a)) is modified to create an in-line-filter (i.e., a band pass filter) by altering the mechanical structure of multiple sections along the length of the micro-coaxial cable. The mechanical structure of the modified sections of the micro-coaxial cable can be achieved by altering the ratio of the outer and inner conductor diameter and/or altering the dielectric layer content between the two conductors. The micro-coaxial cables are structurally modified such that the modified sections of the micro-coaxial reflect or attenuate non-desired RF signals that might interfere with a desired RF signal carried by the modified micro-coaxial cable.

At 804, the modified micro-coaxial cable is cut to length by cutting the modified micro-coaxial cable such that the terminating ends are located within a non-modified section of the micro-coaxial cable. At step 806, the terminating ends are connected between the antenna (e.g., 114) and the wireless radio module (112).

### Exemplary Embodiment

As mentioned above, a high isolation between two radios co-located on the same platform is usually required, such that one radio's transmitted signal does not interfere with the other radio's reception. Conventionally, isolation between two radios' antennas, which is usually provided by spatial separation, provides essential part of this required isolation. Along with proliferation of integrated radios and the industry trend toward perceptual computing, more and more antennas as well as sensors (camera arrays, microphones) are being integrated into laptops/tablets, smartphones and mobile information devices etc., it is becoming very challenging to fit all the antenna required into the platform. This is even the case for maintaining a high isolation between closely spaced antennas 114a, 114b, 114c and 114n as shown in FIG. 1.

Embodiments of the present invention set forth above provide using periodically inserted discontinuities in coaxial cable to create band rejection filter functionalities. Further embodiments set forth herein provides an antenna that may include a same radiating element fed by more than one in-line-filter cables with complimentary pass and rejection bands, and the more than one in-line-filter cables may have periodically inserted discontinuities in coaxial cables to create band rejection filter functionalities.

Looking now at FIG. 9, shown generally as 900, shows the measured insertion loss 905 vs. frequency 910 of the two cable embodiment with targeted rejection band at 2 GHz 3G service 915 and 204 GHz WiFi service 920. As can be seen that with one meter long cable incorporated with filtering functionality, 40+ dB rejections can be achieved while maintaining low insertion loss in pass bands. With the outstanding filtering feature from the cable, the adjacent antennas 114a, 114b, 114c and 114n depicted in FIG. 1 could be placed very close to each other and still maintain a good isolation. Embodiments of the present invention further leverages the benefit of having this in-line filter cable, by combining antenna structures to allow more than one cable to feed the same radiating element, which in turn renders significant real estate savings while maintaining good antenna isolation.

For example, FIG. 10 at 1000 shows a wide band antenna design and the measured return loss of the antenna with a conventional cable 1010, attached at 1020 to radiating element 1005, where coverage from 1.7-2.7 GHz with good return loss performance is achieved. FIG. 11 at 1100 shows the measured return loss 1105 v. frequency 1110 of an antenna fixture with a convention cable.

FIG. 12 at 1200 depicts an innovative antenna design with the same radiating element 1205 as FIG. 10, but instead of using one conventional cable, two in-line-filter cables 1210 and 1215, attached to radiating element at 1220, with complimentary pass and rejection bands are used instead.

As can be seen in FIG. 13 at 1300, from the return loss result 305 measured from each cable port, a dramatically different frequency response is achieved, where an acceptable return loss is maintained within the desired band of operation while a high rejection toward the adjacent radio band is achieved. Wifi antenna return loss is depicted at 1315, 3G antenna return loss at 1320 and isolation at 1310. Consequently, the isolation 1310 between the two ports of the same antenna is very high (>30 dB) as shown in the measured results.

Embodiments of the present invention may refer to mobile devices. A mobile device (also known as a handheld device, netbook, tablet computer, handheld computer, mobile information device, smartphone, or simply handheld) may be a pocket-sized computing device, typically having a display screen with touch input and/or a miniature keyboard. In the case of the personal digital assistant (PDA) the input and output are often combined into a touch-screen interface. PDAs are popular amongst those who require the assistance and convenience of certain aspects of a conventional computer, in environments where carrying one would not be practical. Enterprise digital assistants can further extend the available functionality for the business user by offering integrated data capture devices like barcode, RFID and smart card readers.

Although not limited in this respect, one type of such mobile device is a Smartphone. A smartphone may be defined as device that lets you make telephone calls, but also adds features that you might find on a personal digital assistant or a computer. A smartphone also offers the ability to send and receive e-mail and edit Office documents, for example. Other types of mobile devices may be mobile information devices (MIDs).

Another mobile device may be referred to as a tablet computer. A tablet computer, or simply tablet, is a complete personal mobile computer, larger than a mobile phone or personal digital assistant, integrated into a flat touch screen and primarily operated by touching the screen. It often uses an onscreen virtual keyboard or a digital pen rather than a physical keyboard.

The term may also apply to a “convertible” notebook computer whose keyboard is attached to the touchscreen by a swivel joint or slide joint so that the screen may lie with its back upon the keyboard, covering it and exposing only the screen for touch operation.

Embodiments of the present invention may be integrated into mobile devices such as, but not limited to, those set forth above. For example, as shown generally as 1400 of FIG. 14 embodiments of the present invention have been integrated and tested in a laptop computer 1405. Computer 1405 may use one or more single radiating-element-dual-cable configurations as provided herein and thus more antenna radiating elements 1430 and 1420 can be absorbed to fit in a smaller overall space. The space saved to accommodate additional components such as, for example, but not limited to, a camera array or microphone is illustrated at 1440. Single radiating element for radio 1 1410 is shown at 1420 with a first in-line filter cable from radio 1 1410 to radiating element 1420 shown as 1425; and a second in-line filter cable from radio 2 1415 to radiating element 1420 is shown at 1435. Additionally, another combination antenna to support multiple radios 1415 and 1410 and is a single radiating element for radio 1 1410 is shown at 1430; with a first in-line filter cable from radio 1 1410 to radiating element 1430 shown as 1450; and a second in-line filter cable from radio 2 1415 to radiating element 1430 is shown at 1445.

The antenna efficiency results are shown in FIG. 15, shown generally as 1500, in antenna efficiency 1505 vs. frequency 1550. WiFi antenna with 3G rejection is illustrated at 1510, 3G antenna with WiFi rejection at 1520, regular cable 1530 and chamber sensitivity 1540. As can be seen, the antenna exhibits good efficiency performance in the desired band of the corresponding cable port. In the meantime, very low antenna efficiency in the unwanted band (pass band of adjacent cable) is measured, indicating a very effective isolation”. These results illustrate that the antenna structure provided herein, that may include one or more single-radiating-element-dual-cables, is capable of offering good antenna performance and outstanding isolation between two cable ports, which was conventionally achieved only with two separate antennas placed far apart.

Thus, by utilizing embodiments of the present invention that may incorporate the use of in-line-filter cables, multiple antennas can be placed very close to each other, while maintaining a good isolation. Furthermore, with the use of a single radiating-element-dual-cable configuration as provided herein, more antenna radiating elements can be absorbed to fit in a smaller overall space and may rely solely on cable

### CONCLUSION

Although the subject matter has been described in language specific to structural features and/or methodological acts, it is to be understood that the subject matter defined in the appended claims is not necessarily limited to the specific features, dimensions, or acts described. Rather, the specific features, dimensions, and acts are disclosed as illustrative forms of implementing the claims. Moreover, any of the features of any of the devices described herein may be implemented in a variety of materials or similar configurations.

What is claimed is:

1. An apparatus, comprising:
an antenna, said antenna including a same radiating element fed by more than one in-line-filter cables with complimentary pass and rejection bands, wherein said more than one in-line-filter cables have periodically inserted discontinuities in coaxial cables to create band rejection filter functionalities.

2. The apparatus of claim 1, wherein said antenna is adapted to be shared by multiple radios.

3. The apparatus of claim 1, wherein said more than one in-line-filter cables are two in-line-filter cables.

4. The apparatus of claim 3, wherein one of said multiple radios is operable in a long term evolution (LTE) wireless network and a one of said multiple radios is operable in an institute for electronic and electrical engineering (IEEE) 802.11 wireless network.

5. The apparatus of claim 1, wherein said antenna is incorporated into a laptop computer, a smartphone, a tablet computer or a mobile information device.

6. The apparatus of claim 1, wherein said apparatus relies solely on said more than one in-line-filter cables with complimentary pass and rejection bands to provide required isolation.

7. The apparatus of claim 1, wherein said more than one in-line-filter cables with complimentary pass and rejection are adapted to be used as a duplexer which filters and distributes signals received from said same radiating element to multiple radio modules.

8. A method, comprising:
feeding a same radiating element of an antenna by more than one in-line-filter cables with complimentary pass and rejection bands, wherein said more than one in-line-filter cables have periodically inserted discontinuities in coaxial cables to create band rejection filter functionalities.

9. The method of claim 8, further comprising sharing said antenna by multiple radios.

10. The method of claim 8, wherein said more than one in-line-filter cables are two in-line-filter cables.

11. The method of claim 10, further comprising operating one of said multiple radios in a long term evolution (LTE) wireless network and operating one of said multiple radios in an institute for electronic and electrical engineering (IEEE) 802.11 wireless network.

12. The method of claim 8, wherein said antenna is incorporated into a laptop computer, a smartphone, a tablet computer or a mobile information device.

13. The method of claim 8, wherein said apparatus relies solely on said more than one in-line-filter cables with complimentary pass and rejection bands to provide required isolation.

14. The method of claim 8, wherein said more than one in-line-filter cables with complimentary pass and rejection are adapted to be used as a duplexer which filters and distributes signals received from said same radiating element to multiple radio modules.

15. An apparatus, comprising:
a smart phone adapted to use an antenna that includes a same radiating element fed by more than one in-line-filter cables with complimentary pass and rejection bands, wherein said more than one in-line-filter cables have periodically inserted discontinuities in coaxial cables to create band rejection filter functionalities.

16. The apparatus of claim 15, wherein said antenna is adapted to be shared by multiple radios.

17. The apparatus of claim 15, wherein said more than one in-line-filter cables are two in-line-filter cables.

18. The apparatus of claim 17, wherein one of said multiple radios is operable in a long term evolution (LTE) wireless network and a one of said multiple radios is operable in an institute for electronic and electrical engineering (IEEE) 802.11 wireless network.

19. The apparatus of claim 17, wherein said apparatus relies solely on said more than one in-line-filter cables with complimentary pass and rejection bands to provide required isolation.

20. The apparatus of claim 17, wherein said more than one in-line-filter cables with complimentary pass and rejection are adapted to be used as a duplexer which filters and distributes signals received from said same radiating element to multiple radio modules.
